(19) United States
(12) Patent Application Publication
(10) Pub. No.: US 2017/0095401 A1
(43) Pub. Date: Apr. 6, 2017

(54) DEVICE FOR PROVIDING CARDIOPULMONARY RESUSCITATION GUIDELINES

(71) Applicants: Hanbyul Choi, Smithtown, NY (US); Angel Jung, Tustin, CA (US); Ho Jung Kim, Smithtown, NY (US)

(72) Inventors: Hanbyul Choi, Smithtown, NY (US); Angel Jung, Tustin, CA (US); Ho Jung Kim, Smithtown, NY (US)

(21) Appl. No.: 14/875,148

(22) Filed: Oct. 5, 2015

(51) Int. Cl. A61H 31/00

(52) U.S. Cl. CPC A61H 31/007

(57) ABSTRACT

A device for providing guidelines for cardiopulmonary resuscitation (CPR) includes an input unit operable to receive a gender information of a CPR provider; a. processing unit operable to process the gender information of the CPR provider; and an output unit operable to provide an output. If the gender information of the CPR provider is male, the output unit provides an instruction to the CPR provider to place an end of heel of his hand over a distal end of a sternum during chest compressions. In addition, if the gender information of the CPR provider is female, the output unit provides another instruction to the CPR provider to place an end of heel of her hand approximately 1.5˜2.0 cm above a distal end of a sternum during chest. compressions.

### CROSS-REFERENCE TO RELATED APPLICATIONS

Not applicable.

The present invention relates to a device for providing guidelines for cardiopulmonary resuscitation (CPR), and more particularly, to a device for providing the most appropriate location for hand placement during chest compressions and cautionary warning to a CPR provider.

### BACKGROUND OF THE INVENTION

Chest compressions during CPR increase the internal pressure in the thoracic cavity and provide circulation by direct pressure on the chest. In 2000, the European Resuscitation Council (EEC) published guidelines recommending identification of proper hand placement by placing the middle finger on the point where the ribs join the sternum and then, placing the index finger on the sternum. In 2005, the American Heart Association (AHA) published its CPR guidelines suggesting that chest compressions should be performed toy placing the heel of the hand over the middle of the sternum along the inter-nipple line (INL). In 2010, the AHA made a slight change in its recommendations indicating that one should perform chest compressions over the center of the chest (CoC) by pushing hard on the lower part of sternum. However, a study found that, people without proper training had a hard time finding the CoC during chest compressions. Another study found that chest compressions over the INL was safer than chest compressions over the CoC. In addition, a survey found that they do not precisely push on the lower part of sternum.

Therefore, there has been a need to provide identification of the most appropriate location for hand placement, during chest compressions.

Besides, immediate delivery of cardiopulmonary resuscitation (CPR) by bystanders significantly reduces mortality in patients with sudden cardiac arrest since severe brain damage occurs as early as 4-6 rain after cardiac arrest.[1, 2] As a result, CPR training has targeted the general population without any medical background with several studies evaluating the optimal methods for achieving this goal.

Several studies have demonstrated an association between provider exhaustion and poor quality of CPR and there is evidence that switching roles during the delivery of CPR can reduce fatigue. CPR providers can easily become exhausted, especially when only one rescuer is available or when rescuers are female or relatively thin. Moreover, a study shows that fatigue in middle-aged women providers may result in a low quality of chest compressions despite following appropriate CPR recommendations. In addition, recent studies on the new CPR guidelines have found that emphasis on chest compressions has resulted in low quality performance due to fatigability among CPR providers.

Therefore, there has been a need to provide a warning to CPR providers on significant fatigue, symptoms and changes in hemodynamic parameters after performing CPR.

### SUMMARY OF THE INVENTION

The present invention contrives to solve the disadvantages of the prior art. The present invention provides a device for providing guidelines for cardiopulmonary resuscitation (CPR), and more particularly, to a device for providing the most appropriate location for hand placement during chest compressions and cautionary warning to a CPR provider.

The object of the present invention is to provide a device for providing guidelines for cardiopulmonary resuscitation (CPR), which includes an input unit operable to receive a gender information of a CPR provider; a processing unit operable to process the gender information of the CPR provider; and an output unit operable to provide an output. If the gender information of the CPR provider is male, the output unit provides an instruction to the CPR provider to place an end of heel of his hand over a distal end of a sternum during chest compressions. In addition, if the gender information of the CPR provider is female, the output unit provides another instruction to the CPR provider to place an end of heel of her hand, approximately 1.5˜2.0 cm above a distal end of a sternum during chest compressions.

Another object of the present invention is to provide a device for providing guidelines for cardiopulmonary resuscitation (CPR), which includes an input unit operable to receive a gender information of a CPR provider; a processing unit operable to process the gender information of the CPR provider; and an output unit operable to provide an output. If the gender information of the CPR provider is female, the output unit provides an additional instruction to the CPR provider to place an end of heel of her hand approximately a width of a distal interphalangeal joint of her index finger above a distal end of a sternum during chest compressions.

Still another object of the present invention is to provide a device for providing guidelines for cardiopulmonary resuscitation (CPR) which includes an input unit operable to receive a gender information of a CPR provider; a processing unit operable to process the gender information of the CPR provider; and an output unit operable to provide an output. The output unit provides a warning to the CPR provider that he or she may feel or show significant fatigue, symptoms and changes in hemodynamic parameters after delivery of 5˜10 cycles of hands only CPR.

The advantages of the present invention are: (1) the device of the present invention provides information to a CPR provider on the most appropriate location for hand placement during chest compressions; and (2) the device of the present invention provides a warning to a CPR provider.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows measurement of the length of the sternum with a measuring tape (this length is defined as the distance from the sterna notch to the lower end of the sternum based on palpation with the finger);

FIG. 2 shows measurement of the length of the heel at two points (the heel of the hand, was covered with ink and the hand was stamped onto a piece of white paper in order to measure the length of the heel at two points (H1 & H2) and the darkest portion of the imprint of the heel of the hand, was defined as H1 and H2); and

FIG. 3 shows correlation results (comparison of each correlation results of height, weight and BMI with sterna length/2 (R² value, BMI=6.7, height=9.2, weight=10.4).

### DETAILED DESCRIPTION EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations( by use of the antecedent “about”, it will be understood that the particular value forms another embodiment.

A device for providing guidelines for cardiopulmonary resuscitation (CPR) comprises: an input unit operable to receive a gender information of a CPR provider; a processing unit operable to process the gender information of the CPR provider; and an output unit operable to provide an output. If the gender information of the CPR provider is male, the output unit provides an instruction to the CPR provider to place an end of heel of his hand over a distal end of a sternum during chest compressions, and if the gender information of the CPR provider is female, the output unit provides another instruction to the CPR provider to place an end of heel of her hand approximately 1.5˜2.0 cm above a distal end of a sternum during chest compressions.

In addition, if the gender information of the CPR provider is female, the output unit provides an additional instruction to the CPR provider to place an end of heel of her hand approximately a width of a distal interphalangeal joint of her index finger above a distal end of a sternum during chest compressions.

The output unit may further provide a warning to the CPR provider that he or she may feel or show significant fatigue, symptoms and changes in hemodynamic parameters after delivery of 5˜10 cycles of hands only CPR/

### First Study

The present invention is based on the study submitted by the inventors as manuscript number of AJEM11749 with the American Journal of Emergency Medicine, the disclosure of which is incorporated herein by reference in its entirety.

Objective: there have been no specific guidelines regarding the exact hand placement location for effective chest compressions. This study was designed to identify the optimal hand placement site over the chest during CPR.
Methods: The sternal length (SL) of young Korean adults was measured as the distance from the suprasternal notch to the lower end of the sternum. In addition, the heel width of the hand (H) was measured 1 cm (H1) and 2 cm (H2) proximal to proximal end of the carpal bones. Participants were divided into 4 groups (M: men taller than the mean, M′: men shorter than the mean, W: women taller than the mean, W′: women shorter than the mean), and mean palm heel width (H2) and half sternal length (SL/2) of each group were calculated.
Results: 300 men and 300 women were enrolled. SL positively correlated with height (R²=9.2), weight (R²=10.4), BMI (R²=6.7), H1 (R²=3.4), and H2 (R²=5.0). Mean H2 and SL/2 for the subgroups were M: 8.4 cm, and 10.1 cm, M′:8.3 cm and 9.7 cm, W: 7.6 cm and 10.1 cm, W′: 7.4 cm and 9.5 cm respectively. Mean H2 in men was 1.1-1.6 cm shorter than SL/2 while mean H2 in women was 2.2-2.9 cm longer than SL/2.

Conclusions: During chest compressions, men should place the heel of their hand directly over the lower end of the sternum while women should place the heel of their hand one finger breadth above the lower end of the sternum. In other words, regardless of height, men should provide chest compressions over the lower half of the sternum by placing the end of the heel of the hand directly over the lower end of the sternum. In contrast, women should place the heel of their hand approximately one fingerbreadth above or proximal to the lower end of sternum in order to compensate for the shorter width of their hand compared to the length of the lower-half of the sternum.

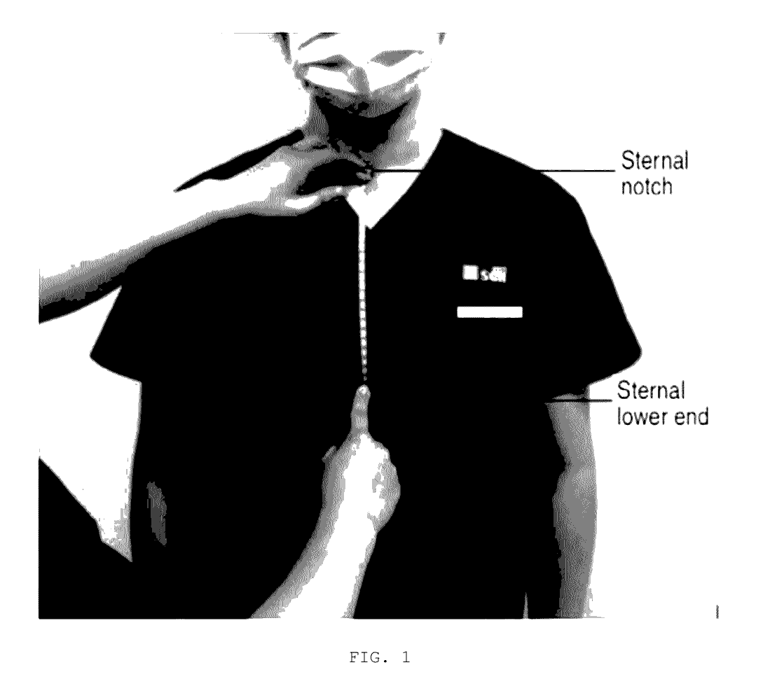

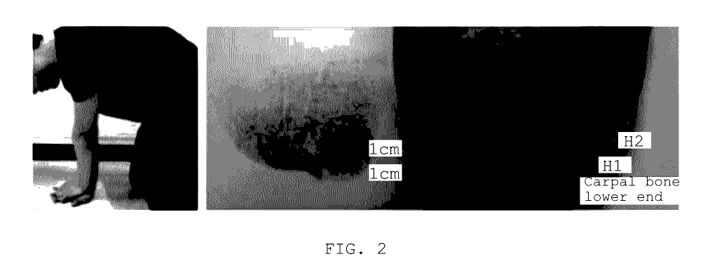

Method: A prospective observational study of hospital staff and students attending a CPR class ages 20-40 was conducted. All subjects gave informed consent and the study was approved by the Institutional Review Board. The height and weight of the study subjects was collected by verbal report, and BMIs were calculated from these data. Sternal length (SL) was measured with a measuring tape from the lowest end of the sternum to the suprasternal notch (FIG. 1). The lowest end of sternum was defined as the junction between the lower margin of ribs and the sternum. In order to better define the heel of the hand, ink was placed on the hands of one male and one female subject, and an impression of their hands was made by “stamping” their hands onto a white piece of paper. We defined the heel of the hand as the darkest point of the print from the reference point, which was the lower or distal end of the carpal bones. Since the defined area was 1-2 cm from the reference point, we measured the width of the heel of the hand 1 cm (H1) and 2 cm (H2) proximal to the reference point (FIG. 2). One emergency medicine resident measured SL and H of all male subjects, while one certified paramedic measured SL and H of all female subjects. Study subjects were instructed to wear thin uniforms to allow accurate measurement of sternal length. The width of the distal interphalangeal joint of the study subjects' index finger was also measured in order to use it as a quick length reference for urgent situations. The primary outcome was the difference between the width of the heel of the hand (both H1 and H2) and half the sternal length.
Results; There were 600 participants in total, including 300 men and 300 women. The mean age of male subjects was 26 years. Mean height, weight, BMI, and SL of male subjects were 173.7 cm, 72.7 kg, 24.5 kg/m², and 19.7 cm respectively. The mean age of female subjects was 25 years. Mean height, weight, BMI, and SL of female subjects were 162.3 cm, 52.8 kg, 18.9 kg/my and 19.2 cm respectively (Table 1). Mean values for H1 and H2 of male subjects were 7.44 cm and 8.23 cm respectively. Mean values for H1 and H2 of female subjects were 6.45 cm and 7.29 cm (Table 1). There were no significant, differences between genders (p>0.05), except for mean height and weight (p<0.05) (Table 1). In particular, mean measurements of SL were 19.7±1.3 cm in men and 19.2±1.9 in women, which were not significantly different (p=0.280) (Table 1).

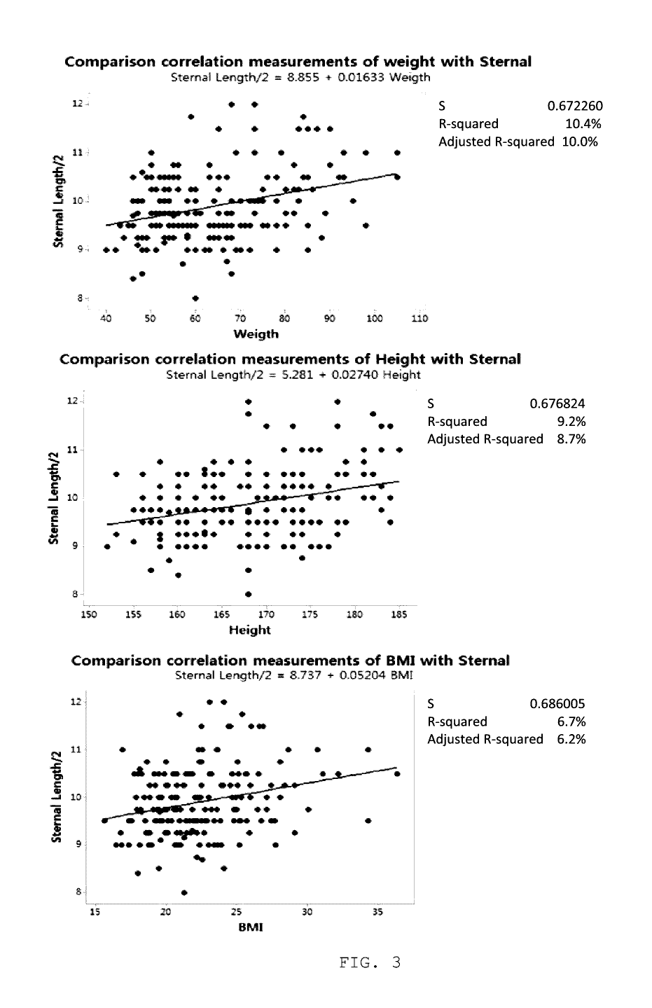

Analysis of the correlation between half of the SL and all other variables (height, weight, and BMI) showed positive correlation with ail of the three variables. R² values from highest to lowest were weight (10.4), height (9.2), and BMX (6.7) (FIG. 3).

Analysis of the relationship between SL and the width of the heel of the hand (H1, H2) demonstrated a weakly positive correlation. The R² value for H2 (5.0) was higher than that for H1 (3.4) (Table 2).

Study participants were divided, into 4 groups based on gender and height, and groups were compared each other (Table 3). Mean values for SL/2 and H2 were compared then compared (Table 3). H2 and SL2 in group M were 8.4 cm and 10.1 cm respectively. H2 and SL2 in group M′ were 8.3 cm. and 9.7 cm respectively. H2 and SL2 in group W were 7.6 cm and 10.1 cm respectively. H2 and SL2 in group W were 7.4 cm and 3.5 cm respectively.

The mean differences between H2 and SL/2 were calculated (Table 4). The difference in length between H2 of group M and SL/2 of all other groups (M, M′, W, W′) ranged from 1.1-1.6 cm. The difference in length between H2 of group M′ and SL/2 of all other groups (M, M′, W, W′) ranged from 1.1-1.6 cm. The difference in length between H2 of group W and SL/2 of all groups (M, M′, W, W′) ranged from 2.2-2.5 cm. The difference in length between H2 of group W′ and SL/2 of all groups (M, M′, W, W′) ranged from 2.4-2.9 cm.

TABLE 1
General characteristics of study participants.

| | Male (N = 300) | Female (N = 300) | p |
|---|---|---|---|
| Age, years | 26 ± 5.1 | 25 ± 4.2 | 0.422 |
| Weight, kg | 72.7 ± 8.8 | 52.8 ± 5.1 | 0.000 |
| Height, cm | 173.7 ± 4.2 | 162.3 ± 4.0 | 0.000 |
| BMI*, kg/m² | 24.5 ± 2.9 | 18.9 ± 2.2 | 0.254 |
| Sternal length, cm | 19.7 ± 1.9 | 19.2 ± 1.9 | 0.280 |
| H1†, cm | 7.44 ± 0.3 | 6.45 ± 0.5 | 0.083 |
| H2‡, cm | 8.29 ± 0.6 | 7.29 ± 0.4 | 0.097 |
| 2^{nd} finger DIP width | 1.8 ± 0.4 | 1.6 ± 0.4 | 0.201 |

*BMI, Body mass index
†H1, width of heel of the hand 1 cm proximal to the proximal end of the carpal bones
‡H2, width of heel of the hand 2 cm proximal to the proximal end of the carpal bones
DIP: distal inter-phalangeal joint

TABLE 2
Association of heel length with sternal length

| | r | P-value | R² |
|---|---|---|---|
| H1 | 0.184 | 0.009 | 3.4 |
| H2 | 0.200 | 0.004 | 5.0 |

H1: Width of the heel of the hand 1 cm proximal to the proximal end of the carpal bones
H2: Width of the heel of the hand 2 cm proximal to the proximal end of the carpal bones

TABLE 3
Comparison of H2 and half sternal length by group

| | H2*, cm | | | SL†, cm | | |
|---|---|---|---|---|---|---|
| | Mean | SD | SE | Mean | SD | SE |
| M | 8.4 | 0.588 | 0.065 | 10.1 | 1.856 | 0.292 |
| M′ | 8.3 | 0.497 | 0.089 | 9.7 | 1.258 | 0.155 |
| W | 7.6 | 0.429 | 0.086 | 10.1 | 1.430 | 0.163 |
| W′ | 7.4 | 0.393 | 0.069 | 9.5 | 1.181 | 0.122 |

*Width of heel 2 cm proximal to the proximal end of the carpal bones
†Length of sternum/2
M: Men taller than the mean height
M′: Men shorter than the mean height
W: Women taller than the mean height
W′: Women shorter than the mean height

TABLE 4
Mean difference in the length of the heel to half the sternal length

| SL†, cm | | | | |
|---|---|---|---|---|
| H2*, cm | M | M′ | W | W′ |
| M | 1.6 | 1.2 | 1.6 | 1.1 |
| M′ | 1.6 | 1.2 | 1.5 | 1.1 |
| W | 2.5 | 2.2 | 2.4 | 2.2 |
| W′ | 2.9 | 2.4 | 2.8 | 2.4 |

*Width of heel 2 cm proximal to the end of the carpal bones
†Length of sternum/2
M: Men taller than the mean height
M′: Men shorter than the mean height
W: Women taller than the mean height
W′: Women shorter than the mean height

Discussion: Chest compressions on cardiac arrest patients can be performed by anybody including people without any medical background. Chest compression is considered to be the most important component of CPR since coronary perfusion pressure drops substantially with any 4-5 sec delay in chest compressions. However, few studies have evaluated the optimal chest location for hand placement during compression. Therefore, the current study greatly expanded the number of subjects enrolled in a previous study, which was too small to represent the general Korean population.

Generally, it is advised to place the heel of the hand over the lower port ion of the sternum. However, the definition of the heel of the hand is ambiguous. Both the Korean Association of Cardiopulmonary Resuscitation (KACPR) and the AHA have indicated that the heel of the hand is the part of the hand between the lower portion of the palm and the upper portion of the wrist. Oh and colleagues used their own subjective definition of the heel of the hand in their analysis. In the current study the heel of the hand was objectively defined by the “hand stamp method” that found the darkest point 2 cm proximal to the lower end of the carpal bones (H2), which was more strongly correlated with SL than H1.

The current study found similar sternal lengths in men and women. In contrast, Shin, and colleagues used CT imaging to measure sternal, length and found statistically significant differences in sternal length between males and females. However, since the study ignored the curved shape of the sternum, it is not useful when actually delivering chest compressions on a real patient. The current study also found that height, weight, and BMI are positively correlated with SL. In particular, weight showed the strongest correlation with SL. However, given that the R2 values for weight and height were similar, height seems to be a more practical and useful predictor of SL than weight during actual chest compressions since weight cannot be easily estimated in an emergent situation.

When subjects were divided into 4 groups (M, M′, W, W′) based on gender and height, there was no significant difference in H between men and women. The groups of subjects (M, W) that were taller than the mean height had slightly longer (0.5 cm) sternums. In all groups (M, M′, W, W′), the mean width of the heel of the hand (H) was shorter than mean half of the sternal length (SL/2). In men the width of the heel of the hand was roughly 2 cm shorter than half the sternal length while in women, the width of the heel of the hand was roughly 2 cm longer than half the sternal length. Based on these findings, in order to deliver effective chest compressions, placement of the heel of the hand should differ based on the CPR provider's gender. Men should place the end of the heel of their hand over the distal end of the sternum during chest compressions while women should place the end of the heel of their hand approximately 1.5 cm-2 cm above or proximal to the distal end of the sternum. Based on the current study, the width of the distal interphalangeal joint of the index finger can be used as a quick reference for approximating a length of 1.5 cm-2 cm (Table 1).

### Second Study

The present invention is based on the study submitted by the inventors as manuscript number of emermed-2015-205281 with the Emergency Medicine Journal, the disclosure of which is incorporated herein by reference in its entirety.

Objectives: Cardiopulmonary Resuscitation (CPR) guidelines emphasize delivery of effective chest compressions but do not strongly address the medical safety of CPR providers. The objective is to determine the effects of chest compressions on healthy adult firefighters' symptoms, hemodynamics, and electrocardiography after performing multiple cycles of CPR.
Methods: Healthy adult firefighters were trained in hands only CPR (rate: at least 100/min, depth: at least 2 inches) and performed hands only CPR on mannequins. Provider vital signs (blood pressure, heart rate, respiratory rate, O₂ saturation, end-tidal CO₂ tension, and pulse pressure), electrocardiography, and fatigue scores (on a scale of 0 to 10 from none to worst) were determined immediately before CPR (T₁), after 5 cycles of CPR (T₂), and after 10 cycles of CPR (T₃). In addition, the presence of clinical symptoms (e.g., shortness of breath, dizziness) among the providers was determined after CPR.
Results: 39 firefighters participated in the study. Their mean age was 35.54±10.26 years. Many providers developed fatigue, shortness of breath, and dizziness. Significant changes in heart rate (_=0.000), respiratory rate (_0.010), end-tidal Co₂ (_0.000), O₂ saturation (_=0.000), and pulse pressure (_=0.000) were observed after both 5 and 10 cycles of CPR. One participant developed sinus dysrhythmia and premature ventricular contractions (PVC) after 10 cycles of CPR.
Conclusions: delivery of chest compression results in fatigue and hemodynamic alterations in many young healthy adults after performing 5 or 10 cycles of CPR. Guidelines and education should take into account the medical safety of CPR providers.
Discussions: Recent CPR guidelines issued by the American Heart Association (AHA) emphasize immediate delivery of (CPR without ventilation). In addition, in 2010, the AHA changed its recommendations on the depth and rate of compression from 38-51 mm to 50-60 mm and from 100/min to 100-120/min respectively. However, emphasis on chest compressions demands physical strength and may cause provider fatigue. Therefore, the current study was specifically designed to assess the medical safety of the CPR provider, by studying the effects of chest compression on fatigue, symptoms, hemodynamics and ECG after performing multiple rounds of CPR.

As recent studies have demonstrated significant changes in vital signs after performing CPR, such as heart rate, ETCO2, and SPO2 or blood pressure and heart rate, this study found statistically significant changes in heart rate, respiratory rate, ETCO2, SPO2, and pulse pressure after 5 or 10 cycles of CPR. Especially, the current study found significant increases in pulse pressure after multiple cycles of CPR. Although it is normal physiologic phenomenon to have an increased pulse pressure after vigorous exercise, such as chest compression, this potentially is a clinically important finding since multiple studies have found that an elevated pulse pressure is associated with cardiovascular disease and increased mortality.

Increases in respiratory rate and ETCO2 combined with decreases in SPO2 are also of clinical relevance based on the fact that 33.3% of the participants reported difficulty in breathing after 10 cycles of CPR. Thierbach and colleagues asked subjects to perform CPR only by ventilation and claimed that artificial ventilation can adversely affect the CPR providers' health due to hyperventilation. However, Kim et al demonstrated an increase in ETCO2 after CPR including both chest compressions and ventilation, which is similar to our observations. This physiological phenomenon is normal response to excessive muscle use during chest compression, which causes a reduction in oxygen diffusion capacity and inadequate perfusion. However it can be potentially dangerous for CPR providers with background medical illness, such as cardiovascular disease.

In the current study one male participant, (height: 163 cm, weight: 69 kg, age: 50), with a prior history of hypertension, developed sinus dysrhythmia and premature ventricular contractions (PVCs) after 10 cycles of CPR (FIG. 2). This participant also complained of difficulty breathing. In addition, his pulse pressure was slightly above normal prior to CPR and rose to 61 mmHg after 5 cycles of CPR. As noted earlier, increased pulse pressure has been shown to be associated with cardiovascular disease and increased mortality, and in 1982 Memon and colleagues reported a case of fatal myocardial infarction following CPR training raising medical safety concerns in CPR providers. The case reported here once again raises the potential danger of performing CPR.

Recent studies recommended switching roles in CPR every two minutes in order to prevent one rescuer from performing chest compressions for more than 5 cycles.[7,10] The current study supports this recommendation by finding that there were significant changes in vital signs after 5 cycles of CPR.

As recent studies found no association between physical characteristics of CPR providers and fatigability during CPR, current study did not find any clinically significant association between BMI and health of CPR providers. Interestingly, current study found that individuals with normal BMI were associated with greater drop in SPO2 after CPR. This phenomenon may be explained as healthier people performed CPR more vigorously utilizing more oxygen.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A device for providing guidelines for cardiopulmonary resuscitation (CPR), comprising:
an input unit operable to receive a gender information of a CPS provider;
a processing unit operable to process the gender information of the CPR provider; and
an output unit operable to provide an output, wherein if the gender information of the CPR provider is male, the output unit provides an instruction to the CPR provider to place an end of heel of his hand over a distal end of a sternum during chest compressions,
wherein if the gender information of the CPR provider is female, the output unit provides another instruction to the CPR provider to place an end of heel of her hand approximately 1.5-2.0 cm above a distal end of a sternum during chest compressions.

2. The device of claim 1, wherein if the gender information of the CPR provider is female, the output unit provides an additional instruction to the CPR provider to place an end of heel of her hand approximately a width of a distal interphalangeal joint of her index finger above a distal end of a sternum during chest compressions.

3. The device of claim 1, wherein the output unit provides a warning to the CPR provider that he or she may feel or show significant fatigue, symptoms and changes in hemodynamic parameters after delivery of 5˜10 cycles of hands only CPR.
